(19) United States
(12) Patent Application Publication
(10) Pub. No.: US 2010/0027281 A1
(43) Pub. Date: Feb. 4, 2010

(54) LED Anti-Collision Light for Commercial Aircraft

(76) Inventors: Stanley E. Waters, Trussville, AL (US); Kenneth W. Martin, Birmingham, AL (US); Jeffery Taylor, Arab, AL (US); Bruce Weddendorf, Huntsville, AL (US)

Correspondence Address: LANIER FORD SHAVER & PAYNE P.C., P O BOX 2087, HUNTSVILLE, AL, 35804-2087, US

(21) Appl. No.: 12/183,999

(22) Filed: Jul. 31, 2008

(51) Int. Cl. B64D 47/02; G08G 5/04

(52) U.S. Cl. 362/470; 340/961

(57) ABSTRACT

An anti-collision light for large, commercial aircraft is disclosed. The light is a self-contained unit capable of easy replacement of any anti-collision light currently in use in any large aircraft using an adapter plate and adapter cable directly connected to 115 VAC 400 cycles from the aircraft. The light includes a plurality of round circuit boards with an annular ring of high intensity, surface mounted LEDs, with a disk having an edge configured as an offset half parabolic reflector made up of a plurality of conical facets. Angles of the conical facets are selected such that light from the LEDs is focused into a plurality of discrete planes from each facet, these planes concentrating the light into planar regions of discrete light intensity as required by the FAA. The disks with reflector edges also serve as heat sinks to dissipate heat developed by the LEDs.

### FIELD OF THE INVENTION

The present invention is related to aircraft anti-collision lights, and more particularly to large commercial and passenger-carrying aircraft anti-collision lights wherein light is produced by light-emitting diodes (LEDs) and focused by reflectors configured to apportion the light in accordance with FAA requirements.

### BACKGROUND OF THE INVENTION

Anti-collision lights for large commercial and passenger-carrying aircraft are intended to attract attention of observers, especially in low light conditions. As such, light from these devices must be broadcast uniformly and in all directions about the aircraft. In order to make the light even more visible, the light is pulsed, as by using a xenon strobe light, so that it flashes at between about 40 to 100 times a minute. In addition to the necessity of emitting light all around the aircraft, regulations imposed by the relevant national governing aviation authorities, such as the Federal Aviation Authority (FAA) in the United States, require that, for a large commercial aircraft, a majority of the light be emitted substantially horizontally and 360 degrees about an aircraft so that any other proximate aircraft at a similar altitude will receive a greater intensity of light. Here, two large aircraft at the same or similar altitude would each receive the greatest intensity of light from the anti-collision light of the other aircraft, with light intensity from the anti-collision light falling off with diverging altitude.

FAA regulations for anti-collision lights for large commercial transport or passenger-carrying aircraft require that the light is rotationally symmetric about a vertical axis with respect to a fuselage of the aircraft. In other words, for a given vertical angle above and below the horizontal plane of the aircraft, the minimum intensity for each horizontal angle around the vertical axis should be the same. Specifically, at a vertical angle of 0 to 5 degrees with respect to horizontal, the light intensity must be 400 candela for 360 degrees around the aircraft. Thus, an anti-collision light for a large, commercial aircraft must provide the brightest light to other aircraft at a similar altitude. As altitude between two such aircraft begins to differ, 240 ECP must be provided between aircraft at between 5 to 10 degrees vertical divergence, 80 ECP between aircraft at 10 to 20 degrees vertical divergence, 40 ECP between aircraft at 20 to 30 degrees vertical divergence, and 20 ECP for aircraft between 30 to 75 degrees vertical divergence.

Exterior lighting of large aircraft includes running lights, navigation lights that designate port and starboard, and the flashing anti-collision lights that are typically mounted on top of and underneath a fuselage of the aircraft. In addition, there may be a white running light mounted to a tail of the aircraft. These lights typically utilize incandescent filament-type lamps, and as noted, the anti-collision light is usually a xenon strobe light using a xenon flash tube of a circular design. None of these lamps are particularly robust as they all employ a hot filament to generate light, or in the case of a xenon flash tube, use hot filaments at each end of the flash tube to initiate an electrical discharge through the flash tube. As such, takeoff and landing shocks, in addition to in-flight vibration, causes all of these lamps to fail frequently. Particularly, xenon flash tubes rarely last longer than a month or so on regularly used commercial aircraft. These flash tubes are expensive; a flash tube from DEVORE AVIATION CORP., at current prices, being $870.00, this not including labor costs to replace the tube. One large carrier estimates that it spends approximately $1 million per year per type aircraft changing light bulbs and flash lamp tubes. In addition, for a xenon anti-collision light, power supplies needed to drive the flash tubes are heavy, as they employ large transformers and banks of capacitors.

Yet another problem in general with large aircraft of different manufacture is that each of these different large aircraft require differently configured anti-collision lighting parts. As a single airline carrier may have several different types of aircraft, just for an anti-collision light the airline carrier must have on hand to service these anti-collision lights at each repair facility a quantity of each of perhaps 100 or more different parts. By way of contrast, a carrier would only need to stock a quantity of 6 or so different parts using Applicants proposed anti-collision lights, these parts being easily retrofittable to and interchangeable between all large commercial aircraft. Once retrofitted, the same lamp assembly may be installed on all retrofitted aircraft types.

LED anti-collision lights are known in the prior art for smaller, general aviation aircraft. One known anti-collision light is disclosed in U.S. Pat. No. 6,483,254, issued Nov. 19, 2002, and which discloses a ring array of LEDs arranged to emit light directly in a horizontal direction with respect to a fuselage in a strobe-like manner and in all directions. Successive rings of LEDs may be stacked as desired. However, one drawback appears to be insufficient heat sinking, as the heat sink is constructed as a thin ring only as wide as the spacing between leads of the LEDs. Where LEDs are fully powered, even only if in a pulse mode, heat buildup would become a problem. Yet another problem is that since the LEDs are in parallel on each ring with the rings stacked in a series configuration, current flow through each ring is divided between 16 LEDs. Thus, if one LED were to fail, the current would then increase for the other 15 LEDs of the ring, increasing probability of failure of that entire ring and subsequent rings. Further, no disclosure is provided as to how light is focused or directed to meet FAA requirements for dispersing or focusing the light from an anti-collision light from large aircraft as noted above.

Another prior art device is U.S. Pat. No. 6,428,189, issued Aug. 6, 2002, and which discloses a metal plate behind a circuit board, with the circuit board having openings positioned where a LED is mounted. Such an arrangement is designed for LEDs having a heat sink so that the heat sink may protrude through the circuit board and contact the metal plate, drawing heat from the LED. While this design may work well with relatively low power LEDs, it is unclear whether such a scheme would work with the high power, high intensity (up to 700 milliamps) surface mounted LEDs used in the instant invention. Further, there is no disclosure how this array may focus or direct light to meet FAA requirements for large aircraft.

Yet another prior art device is a general aviation anti-collision light disclosed in U.S. Pat. No. 6,994,459, issued Feb. 7, 2006, and which discloses an array of LEDs and an overlying set of lenses, internal reflection structures, ridges and waveguides for each LED, the waveguides and lenses configured to direct light in any desired direction. As noted, this light is only suitable for general aviation purposes, and is not capable of producing sufficient light intensity or distribution for use on commercial and passenger aircraft.

A similar general purpose aviation light is produced by Whelen Engineering Company of Chester, Connecticut, model number 90088 et al, and which is an anti-collision light having 2 banks of 7 LEDs each. This unit, while suitable for FAA standards for small aircraft, is incapable of producing sufficient light for a commercial or large passenger-carrying aircraft to meet FAA requirements, or distributing the light into a pattern as required by the FAA.

Yet another general aviation light is disclosed in U.S. Pat. No. 7,236,105 to Brenner et al, and which discloses a pair of annular circuit boards each having a ring of LED chips mounted directly to the circuit boards. Each LED is surrounded by a circular frame with edges that may be 45-degree reflectors, the frame filled with a transparent material that is poured in place over each LED. Inboard each ring of LEDs is mounted a parabolic reflector. Problems with this device are that no provisions are made for heat sinking. As there are 20 diodes on each circuit board, each of the LEDs driven at between 0.5 to 0.8 amps, heat buildup in the circuit boards and LEDs will be substantial, and cause premature failure of the LEDs. In addition, there is no disclosure that this anti-collision light is capable of dispensing light in the required vertical dispersion planes as required to meet FAA certification for large, commercial aircraft.

From the foregoing, it is apparent that there is a need for a large commercial and passenger-carrying aircraft anti-collision light that meets FAA requirements, is compact and light, relatively inexpensive, has a long lifespan and that can be easily and conveniently fitted and retrofitted on various types of large commercial and passenger-carrying aircraft using replacement parts that are common to each retrofitted large commercial and passenger-carrying aircraft.

### BRIEF DESCRIPTION OF THE DRAWINGS

FIG. 1 is a view through my new commercial aircraft anti-collision light.

FIGS. 1a and 1b illustrate mounting details for mounting my new anti-collision light in an aircraft.

FIGS. 1c and 1d show adapter plates for mounting my new anti-collision light to different commercial aircraft.

FIG. 2 is a top view of a LED array of my light.

FIG. 3 is a pictorial view of a reflector of my new light.

FIG. 3a is a pictorial view of an outer end reflector of my new anti-collision light.

FIG. 4 is a sectional view of a reflector of my new anti-collision light and illustrating construction details thereof.

FIG. 5 is a sectional view of a LED of my new anti-collision light illustrating its relationship with the reflector, and further illustrating how the reflector focuses light from the LED.

FIG. 6 is a pictorial view of an innermost reflector of my new anti-collision light.

FIG. 7 is an electrical block diagram of circuitry powering my new anti-collision light.

FIG. 8 is a flowchart illustrating a method of operation of my new anti-collision light.

FIGS. 9a, 9b, and 9c illustrate schematic diagrams showing how different adapter cables are used to connect the same anti-collision light to different aircraft.

### DETAILED DESCRIPTION OF THE DRAWINGS

It is initially noted that the drawings of the disclosure are not to scale, and are illustrative of only one embodiment of the invention. Also, in some drawings, like reference numbers designate the same or identical openings or components of the instant invention.

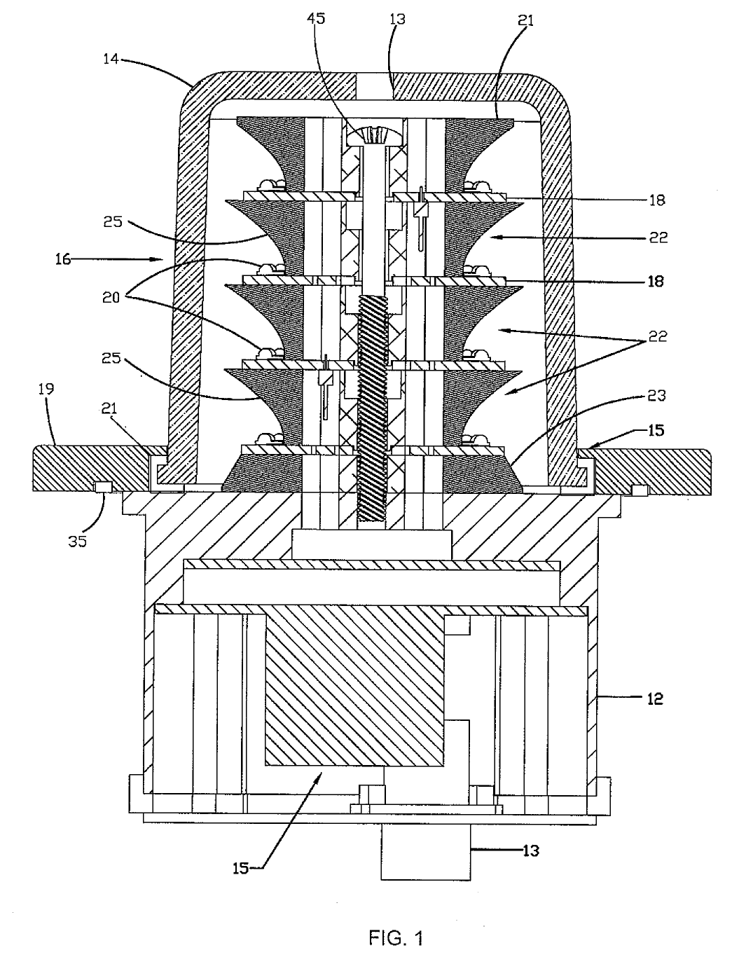

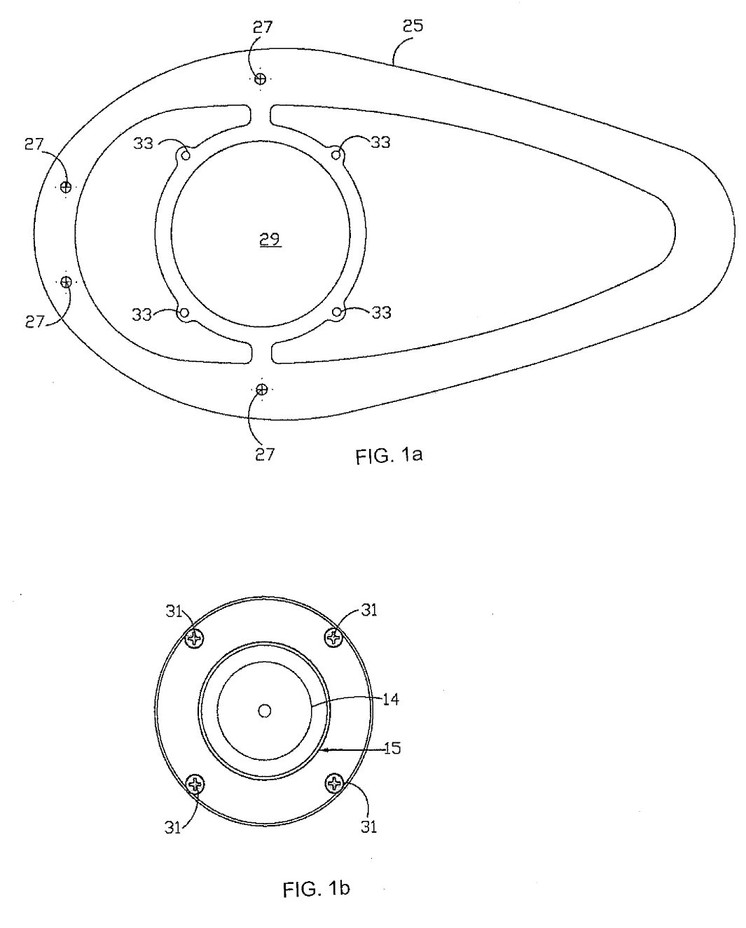

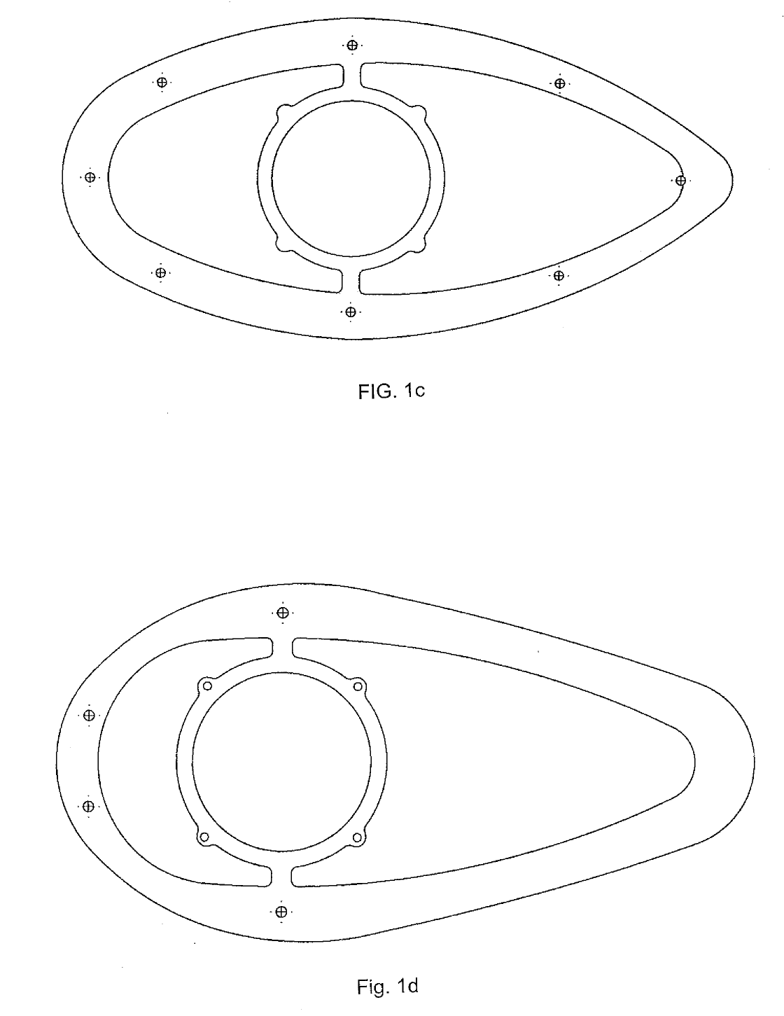

Referring initially to FIG. 1, an anti-collision light 10 of the instant invention is shown. Applicant's anti-collision light 10 is a small, fully self-contained unit having an elongated housing that includes an enclosure 12 that fits into a larger opening in commercial aircraft that would otherwise receive the base portion of a conventional anti-collision light. Enclosure 12 is substantially smaller than bases of other conventional anti-collision lights used on commercial aircraft, with an adapter plate used to fit or integrate enclosure 12 into respective anti-collision light openings of any large aircraft. A power connector 13 receives conventional commercial aircraft power for powering anti-collision lights, i.e. 115 volts at 400 cycles, from the aircraft and which is available to typically drive a xenon strobe light. In many aircraft, a conductor carrying a synchronization signal may also be provided in order to provide a synchronization signal to synchronize all flashing beacons on an aircraft so that they flash at the same time or in a predetermined sequence, this signal also carried via power connector 13. This electrical power and synchronization signal is provided to a power supply 15 within enclosure 12, as will be further explained. On an exterior of the commercial aircraft, the housing includes a transparent dome 14, which may be fabricated of a polycarbonate material, or any other suitable transparent material, is mounted, as by interlocking flanges or lips 15, on the dome and opening of bezel plate 19, respectively Gaskets 21 may be used between the dome and enclosure to seal dome 14 and enclosure 12 from the elements. An opening 13 may be provided in an end of dome 14, opening 13 used as a vent or drain, depending on whether the light is mounted on an upper surface or lower surface of the aircraft. Significantly, and with this construction, dimensions of the housing of my new anti-collision light, including the power supply and logic circuitry for driving the LEDs of the light, are about 3 inches in diameter and about 6 inches long. As such, my new anti-collision light can be used to replace a larger strobe or rotating beacon light mounted to the aircraft, and a larger and heavier power supply mounted within the aircraft.

FIGS. 1a and 1b show how the anti-collision lights of the instant invention are mounted to an aircraft. An adapter plate 25, the particular one shown in FIG. 1a configured for being fitted to a Boeing 757/767 aircraft, is provided with fastener mounting openings 27 for mounting the adapter plate to an aircraft in place of the original anti-collision lamp assembly and ancillary equipment, including the lamp base, lens, power supply and every other component associated with the original anti-collision lamp. The adapter plate 25 is provided with an opening 29 through which enclosure 12 (FIG. 1) of the anti-collision light is fitted, with screws 31 (FIG. 1b) extending through bezel ring 19 of enclosure 12. Screws 31 engage threaded openings 33 (FIG. 1a) in adapter plate 25, securing enclosure 12 of the light assembly to adapter plate 25. A seal 35 (FIG. 1) which may be an O-ring or the like, seals bezel ring 19 against adapter plate 25 to prevent leakage of water into the aircraft. An example of another adapter plate for receiving the anti-collision lights of the instant invention is shown in FIGS. 1c and 1d; FIG. 1c showing an adapter plate for a DC-10 and as noted, FIG. 1d showing the adapter plate for a Boeing 757/767.

Transparent dome 14 (FIG. 1) houses a stack of circuit boards 18, each of which having a plurality of surface-mounted, high intensity LEDs 20 mounted about a periphery of the circuit boards. Each of these LEDs is provided with a metallic pad for contact with a heat sink in order to dissipate heat. Interspaced between the circuit boards and thermally intimate with the circuit boards and metallic pads of the LEDs are disks 22 each having edges 25 particularly configured as reflectors that receive light from the LEDs, which reflector edges 25 serving to focus light from the LEDs into a pattern of light meeting FAA requirements as noted above. Significantly, disks 22 are constructed of a material so that the disks serve as heat sinks to dissipate heat generated by electrical power applied to the LEDs. A thermally transmissive, electrically insulative tape or compound typically may be used between each side of a circuit board and an adjacent disk in order to provide efficient heat transfer between each circuit board and the adjacent disk.

The light emitting diodes (LEDs) are high-intensity LEDs that, by way of example only, may be LUXEON® REBEL-type surface mount LEDs, manufactured by PHILIPS, INC. and which are currently available in a number of different colors, with the red version producing a typical luminous flux of up to 100 lumens and the red-orange version producing 100 lumens, each version capable of being driven at up to 700 milliamps. As noted, a metallic thermal pad is provided on each LED in order to conduct heat to a circuit board and subsequently to an adjacent disk. While these particular LEDs may be used with the anti-collision light of the instant invention, other high-intensity LEDs of different manufacture may also be used, and the present invention should not be construed as being limited to or requiring these particular LEDs. Where different LEDs are used, it should be apparent that the circuit boards may be modified to use such different LEDs in accordance with the principles of the instant invention.

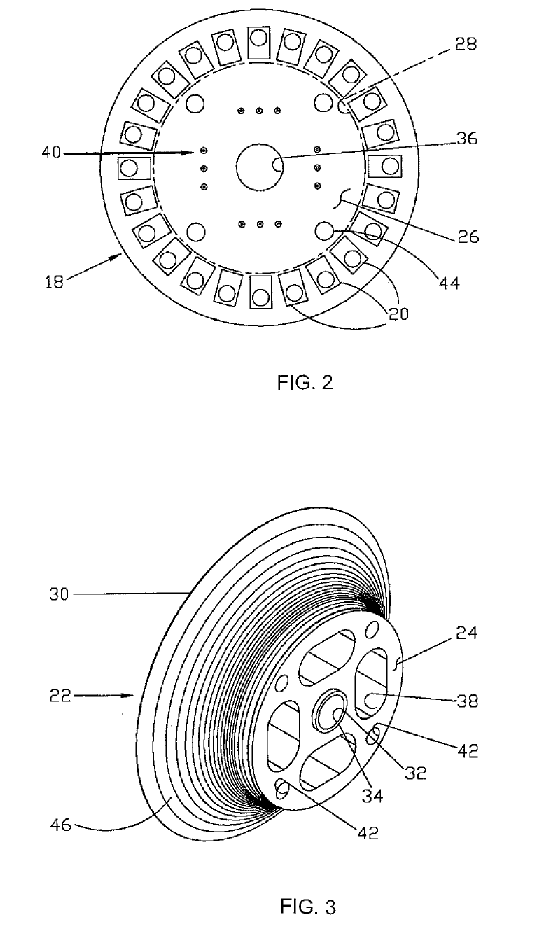

FIG. 2 illustrates a top side of one of circuit boards 18 to which LEDs 20 are mounted. As shown, these circuit boards are round, and approximately 1.75 inches in diameter. These circuit boards may be constructed having an inner layer of copper or other heat-conducting material, with an exterior layer on each side of the copper being of thin circuit board-type material, such as fiberglass or the like. Electrical traces that convey current to the LEDs are laid on the fiberglass layer, and coated with a circuit board-type coating, which may be a non-conductive epoxy or other insulative material typically found on circuit boards. In addition, the layer of thermally conductive double sided tape is mounted between each side of the circuit board and an adjacent heat sink/reflector disk to further insulate the circuit boards and facilitate conduction of heat away from the LEDs. With this construction, heat is readily passed through the circuit board-type material to the heat sink/reflector disks, as will be further explained. In addition, there are about 800 or so small openings, or “vias”, on each circuit board, the interior of these openings being coated with a metal, such as copper, these small openings functioning to increase surface area of the circuit boards to facilitate heat dissipation in accordance with the mounting of the LEDs, as recommended in PHILIPS technical datasheet D56, which is incorporated herein in its entirety by reference.

On each of these circuit boards, there are 24 high-intensity LEDs mounted about the periphery of each circuit board 18 so that light from the LEDs is directed upward or downward along an axis of the anti-collision light with respect to a fuselage of the aircraft, depending on where on the aircraft the anti-collision light is mounted. As noted, each circuit board is constructed including a thin, thermally conductive center layer, such as aluminum or copper, to readily pass heat to upper and lower reflector/heat sink disks between which each circuit board is mounted.

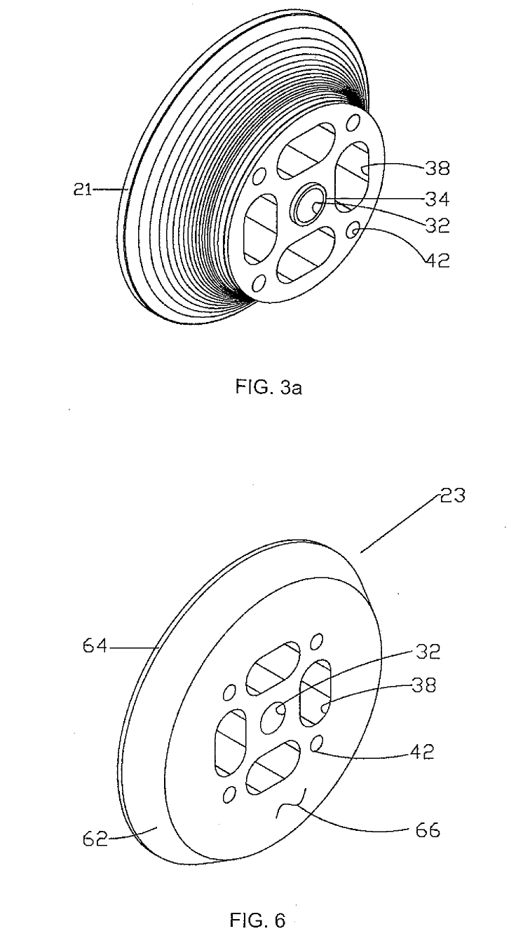

Three of disks 22 are configured as shown in FIG. 3, these disks positioned between end reflectors 21 and 23 (FIG. 1). These disks 22 are of circular configuration, and constructed having a flat, smaller-in-diameter base portion 24 that may be about 1.2 inches in diameter, and which bears against a side 26 (FIG. 2) of circuit boards IS and inboard of LEDs 20 as indicated by dashed line 28. Each of these disks 22 may also be is about 0.5 inches thick. As stated, disks 22 are constructed of a thermally conductive material, such as aluminum, and particularly may be constructed of an aluminum alloy ANSI 7075-T6 per QQ-A-225/9 so that heat from the circuit boards is readily conducted into the reflectors/heat sinks on opposite sides of each circuit board. As noted above, a thermally conductive, electrically insulative tape or compound is positioned between both sides of each heat sink/reflector disk and an adjacent circuit board to facilitate heat transfer to the heat sink/reflector disk and insulate the electrical potentials applied to the circuit boards from the heat sinks. While use of this particular aluminum alloy is disclosed, other materials and alloys of aluminum, or any other suitable heat transfer material that may also be coated with a bright reflective coating, may also be used.

Each of these disks 22 is further configured on a side opposite base portion 24 as a broader, flat region 30 that may be about two inches in diameter, and which bears against the entire width and breadth of a side of circuit boards 18 opposite to that upon which the LEDs are mounted, as shown in FIG. 1. A central opening 32 (FIG. 3) is provided through each of disks 22, which opening may be provided with a small lip 34 that serves to engage or extend at least partially through a central opening 36 in circuit boards 18, lips 34 and openings 36 cooperating to accurately locate side regions 24 of the disks within dashed lines 28 of the circuit boards just inboard LEDs 20. Elongated openings 38 in each of disks 22 allow passage of wires (not shown) for providing power to each of circuit boards 18, with each circuit board also having sets of openings 40 (FIG. 2) for allowing passage of wires through lower circuit boards to circuit boards higher in the stack of circuit boards/disks that makes up the anti collision light. Other openings 42 in the disks 22 communicate with openings 44 in the circuit boards through which an alignment pin, such as a roll pin, may be passed, which roll pins holding the stack of circuit boards/disks in proper alignment. A single screw 45 extends through the central openings in the disks and circuit boards and engages a threaded opening in housing or enclosure 12, holding the stack of circuit boards and disks together. A locking compound may be used between threads of the screw and a respective threaded opening so that the screw does not loosen from vibration.

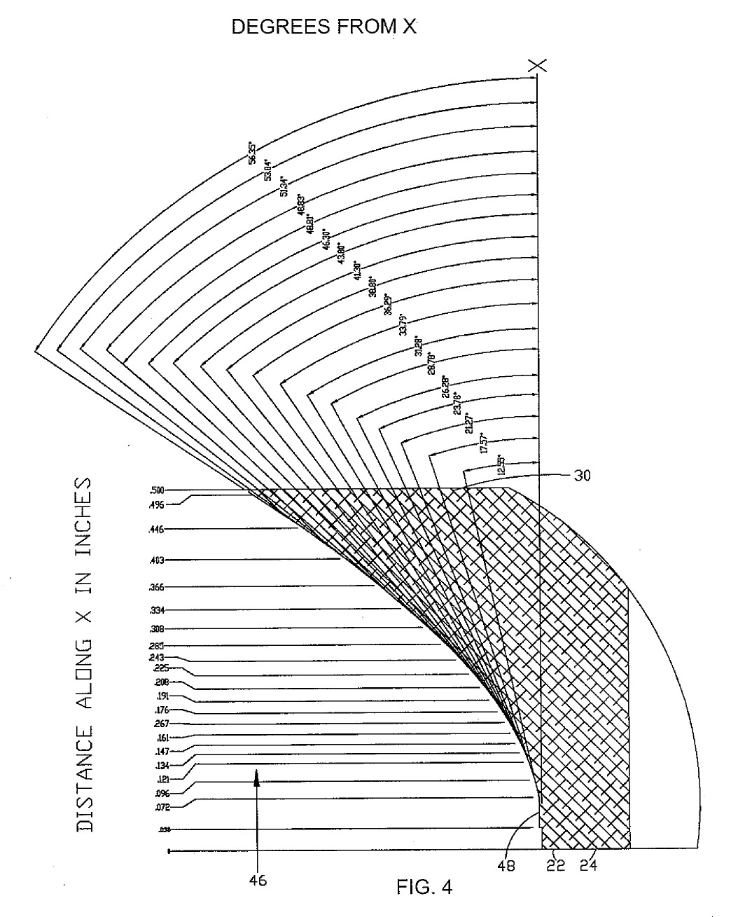

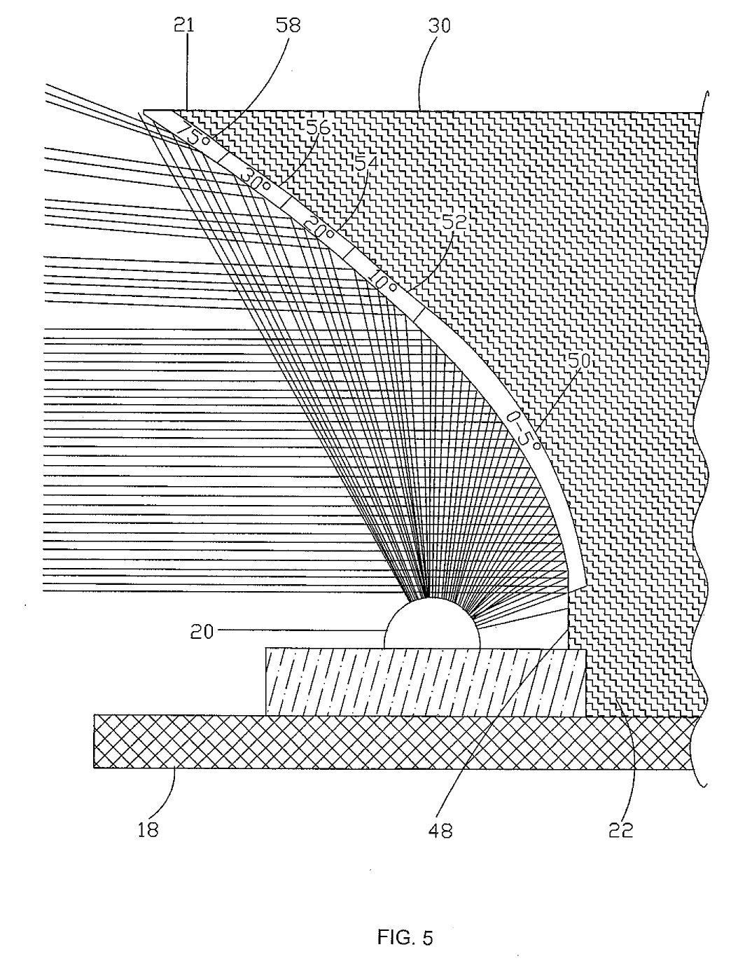

Construction details of a concave edge 46 of disks 22 is configured as shown in the cross sectional and broken away view of FIG. 4. Here, a plurality of conical reflecting facets are cut or formed into the material of edges of each disk and around the side of the disk as the disk widens toward end 30 thereof, with width of each conical reflecting facet defined by its distance along X, which is a line parallel with an axis of the disk. The angles from X of the conical portion of each facet are unique for that disk, beginning with the first reflecting facet at 12.55 degrees from line X, and increase as indicated. Together, the angles of the facets and widths of the facets cause the reflector edge 25 to generally be shaped as a truncated concave cone, or in cross-section, an offset half parabolic reflector. While the reflector edge 25 of disks 22 are disclosed and shown as having reflecting conical facets, the sides of the reflector edges may also be constructed as a smooth surface. However, it is believed the conical reflecting facets are more effective at focusing light from the LEDs as required by the FAA into plane regions having specified intensities due to each facet serving as a planar surface that reflects incident light from the LEDs. These planar surfaces of each of the facets are believed to exert more control to prevent unwanted dispersion of the light. As such, each conical facet directs incident light into a discrete plane of a plurality of discrete planes, these discrete planes forming regions of selected intensity and divergence, as shown in FIG. 5. As such, the angles of the conical facets control the intensity of each plane region. One formula that may be used to generally describe such a surface, or a surface defined along centers of the facets, may be as follows:

Ax²+Bxy+Cy²+Dx+Ey+F=0

The reflective facets of sides 46 of each disk 22 are polished, and coated or plated with a bright nickel plating per ANSI AOC-EN-000, with chrome being plated over the nickel coating. In some instances, the chrome plating may be omitted. Again, other suitable platings and plating materials may be used to achieve the stated operational characteristics of the invention.

With respect to how light is reflected from edges 25 of the heat sink/reflector disks 22, reference is made to FIG. 5, which shows light distribution and focusing by the facets of reflector edge 25 in a single plane through one of LEDs 20. It should be recalled that, for each reflector edge 25, light from 24 LEDs is focused in this pattern 360 degrees around each of disks 22. Here, light from one of LEDs 20 directed onto reflector edge 25 is focused by the reflecting comical facets into planar regions 50-58, each of these planar regions having a selected intensity of light. A first region as indicated by arc 50 is provided wherein light is focused to an intensity of at least 400 candela, this region of relatively high-intensity light diverging by only about 5 degrees from a line normal to the axis of the disk and housing of the anti-collision light. Successive regions as indicated by arcs 52-58 of the reflector edge 25 generally define planar regions where light intensity is 240 candela for 5 to 10 degrees divergence (arc 52), 80 candela for 10 to 20 degrees divergence (arc 54), 40 candela for 20 to 30 degrees divergence (arc 56), and 20 candela for 30 to 75 degrees divergence (arc 58). As noted above, these planar regions extend 360 degrees around the axis of the disks due to placement of the LEDs around the conical reflecting facets of the reflector edge 25.

The outermost disk 21 of the stack (FIG. 3a) has a reflector edge that is generally configured as shown in FIGS. 3 and 4, but is truncated approximately at dashed line or edge 21 (FIG. 3a, 5). This truncation makes end 30 of the disk about 0.01 inches in diameter smaller than ends 30 of disks 22, or about 1.8 inches in diameter, allowing more light to escape directly from the LEDs from an end of the anti-collision light in the 75 degree divergence region.

At an opposite end of the stack nearest the fuselage of the aircraft, disk 23 is configured as shown in FIG. 6. This disk may be about 0.25 inches thick, about two inches in diameter across the widest side 64 and about 1.75 inches across the smaller diameter of side 66. In addition, the various openings through disk 23 are the same as described for disks 22, and lip 34 (FIG. 3) is not needed. Unlike the other disks, an edge 62 of disks 23 is conical, and may be angled at about 30 degrees from an axis through opening 32 of the disk. As described for disk 22, edge 62 is also polished and coated with a bright nickel plating over which a chrome plating may be applied.

As noted above, this construction makes the anti-collision light of the instant invention considerably smaller than conventional anti-collision lights, dome 14 being slightly less than 2.75 inches in diameter, and extending only about 2.6 inches or so into the wind stream about the aircraft. As such, the entire lamp assembly, which includes the power supply for converting 115 VAC 400 cycles to 40 volt DC to energize the LEDs and logic circuits to control flashing of the LEDs is on the order of about 6″ long and 3″ in diameter and weighs about 1.7 lbs.

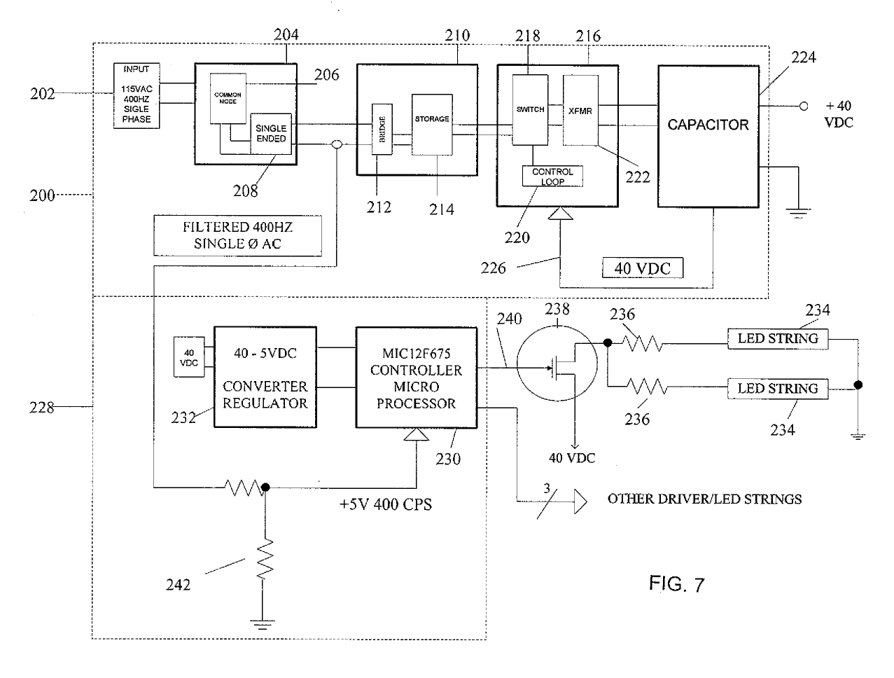

For powering the LEDs, and as a feature of the invention, reference is made to FIG. 7, an electrical block diagram of power supply 15 (FIG. 1) of the invention. Typically, on commercial aircraft, relatively large and heavy transformers are used in power supplies mounted within the aircraft frame or wing separate from the light assembly in order to convert the conventional 115 VAC at 400 cycles found on such commercial aircraft to a voltage used to power either incandescent lights or a strobe lamp. Thus, there is typically power supply mounted within the aircraft, and a separately mounted anti-collision light. Here, rather than using a transformer-type power supply to reduce the 115 volt, 400 cycle power to a potential usable by the LEDs, Applicant uses a switching power supply in order to greatly reduce EMI emissions and reduce size and weight of the power supply so that the switching power supply may fit in enclosure 12. In addition, such a power supply and logic circuits are small and lightweight, allowing it to be fitted within enclosure 12 of the light assembly, as shown in FIG. 1. This power supply is designed to operate from −50 to +130 degrees Fahrenheit, and provides a constant 40 volts DC output with an input power range of from about 80 VAC to 130 VAC.

As shown in FIG. 7, power supply 200 (dashed lines) receives single phase 115 VAC, 400 cycles, at box 202. Initially, power is filtered by a filter 204 to eliminate any EMI noise that may be present, and may be constructed as shown using a common mode filter 206 and a single ended filter 208. The filtered AC power is then applied to a rectifier 210, which may include a bridge rectifier 212 and a smoothing capacitor 214. The rectified and smoothed 115 volt, 400 cycle power is applied to switching portion 216 of the power supply, switching portion 216 including a switch 218, which may be a transistor switch, and controlled by a control loop 220 so that switch 218 is operated to provide 100 kHz to transformer 222. Such a high frequency of the switch allows transformer 222 to be much smaller than a conventional AC voltage reducing transformer that would otherwise be necessary.

Transformer 222 reduces the switched output of 100 kHz 115 volt potential to a voltage such that when applied to smoothing capacitor 224, which smoothes the power potential and removes ripple produced by transistor switch 218, a stable 40 VDC is provided. A feedback loop 226 allows control loop 220 to maintain a regulated 40 volt output as the LEDs are switched ON and OFF.

Still referring to FIG. 7, the 96 LEDs of the anti-collision light are driven by a driver circuit 228 (dashed lines). A microcontroller or microprocessor 230 is used to control functions of driver circuit 228, making the anti-collision light configurable to any of the different large commercial aircraft on which it is contemplated to be used. Microcontroller 230 may be a microcontroller such as a microcontroller available from MICROCHIP TECHNOLOGY, INC.®, part number PIC12F629/675. This processor is an 8 bit, flash based CMOS microcontroller as described in the MICROCHIP TECHNOLOGY, INC.® data sheet no. DS41190C, which is incorporated in its entirety herein by reference. While use of this particular microcontroller is described, it should be apparent to one skilled in the relevant art that other microcontrollers or microprocessors exist that may be used to perform the functions of the instant invention.

For powering the microprocessor, 40 volt power from switching power supply 200 is applied to converter/regulator 232, which converter/regulator converting the 40 volt power to a regulated voltage suitable for microcontroller 230, which for the described microcontroller is +5 volts DC. One suitable converter/regulator circuit may be based on a regulator part no. LM9076 manufactured by National Semiconductor®, as described in their data sheet DS200830, which is incorporated in its entirety herein by reference. As with the microcontroller, it should be apparent that other voltage regulator-based circuits may be used to perform the functions suitable to supply the appropriate voltage for the microcontroller.

Still referring to FIG. 7, the 96 LEDs of the anti-collision light are connected in series strings 234, with 12 LEDs connected in series per string so that there are 12 strings of LEDs in the anti-collision light. As should be apparent, each of the LEDs in each series string is connected cathode-to-anode from the +40 volt power so as to pass current applied through resistor 236. The current limiting resistor 236 is connected in series between a power switching device 238, which may be a power transistor, or as shown, a power field effect transistor (FET). Current limiting resistors 236 are each selected to have a value such that about 250 milliamps is passed through each string of LEDs, powering each of the LEDs at 250 milliamps and for a duration of about 250 milliseconds. As such, each of the 96 LEDs is driven at less than half their rated capacity, insuring long life from the LEDs, as well as relatively low heat generation. As such, each FET handles about 500 milliamps, with all the strings of LEDs being powered by about 2 amps of current at about 40 volts DC. Each gate 240 of a respective FET is connected or coupled to an appropriate output pin of microcontroller 230 so that when a gate 240 of the FET is triggered by an output from microcontroller 230, the associated FET 238 is driven into conduction, providing the 500 milliamps through a respective current limiting resistor 236 to a pair of strings 234. As a safety feature, the FETs 238 are of a type so as to have a thermal shutdown capability configured so as to pinch off current flow at around 800 millivolts or so in the event of a malfunction. With this construction, in the event of such a malfunction, the other strings of LEDs will continue to operate. While only a single FET 238 and associated pair of strings 234 of 24 LEDs are shown (12 LEDs/string), three other like power switching devices 238 coupled as shown to microcontroller 230 are used, each of which powering respective pairs of strings 234.

In most large commercial aircraft, a synchronization signal is developed by the aircraft and provided to all blinking or flashing lights on the aircraft so that all these lights flash simultaneously or in a predetermined sequence In most of these aircraft, this signal is provided on a power conductor as a brief interruption of the 115 volt 400 cycle power lasting at most, a few cycles. As such, a separate conductor carries a 115 VAC 400 cycle power potential that drops one or a few cycles to signal an impending flash. After such a synchronization signal is detected, a short time delay is allowed to pass, after which all the flashing lights are then energized for the interval of the flash. In order to detect these dropped cycles, a voltage divider network 242 divides the 115 volt 400 cycle power provided to power the flashing lights down to about 5 volts at 400 cycles, and applies this signal to the appropriate input pin of microcontroller 230 wherein the 400 cycle potential may be monitored for dropped cycles, as should be apparent to one skilled in the art given the incorporated-by-reference data sheet for the microprocessor.

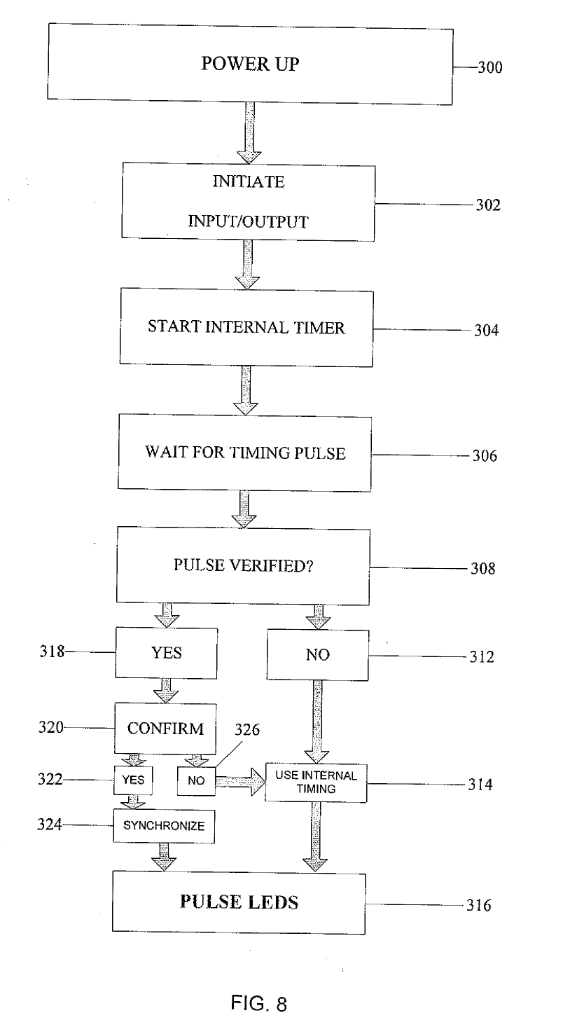

With respect to FIG. 8, a typical flowchart of software for the microprocessor controller is shown. At box 300, power is applied to the system, and at box 302 microcontroller 230 is initialized. At box 304 the internal timer, or clock, for microcontroller 230 is started, and the microcontroller waits at box 306 for the synchronization signal as discussed above that signals an impending flash of all the aircraft lights. After a first synchronization signal is received, the microcontroller is nonresponsive to flash the LEDs until a second synchronization signal is received, this second signal serving to confirm or verify a time period between the synchronization signals at box 308. As such, it may be that the first synchronization signals may pass before the anti-collision light of the instant invention identifies the time interval between the synchronization signals and begins to flash the LEDs in a synchronized manner with the other flashing lights of the aircraft. Thus, a NO 312 from box 308, indicating the synchronization signal has not been verified, causes the microcontroller to use a default 60 flash per minute flash rate at box 314, and the LEDs are energized for a flash at box 316. If a synchronization signal is verified at box 308, meaning that at least two consecutive synchronization signals are received, resulting in a YES at box 318, then the microcontroller waits for one flash interval at box 320 for another synchronization signal. If this subsequent synchronization signal is received at a predetermined time after the prior synchronization signal, as indicated by a YES at box 322, then the microcontroller locks onto this time interval at box 324 and begins to flash the LEDs responsive to received synchronization signals at box 316. In the event the synchronization signal is not confirmed at box 320, as indicated by a NO at box 326, the microcontroller defaults back to the 60 flash per minute flash rate. With this programming, in the event the microcontroller cannot lock onto a predetermined synchronized flash rate, the microcontroller will still flash the LEDs at 60 flashes per minute.

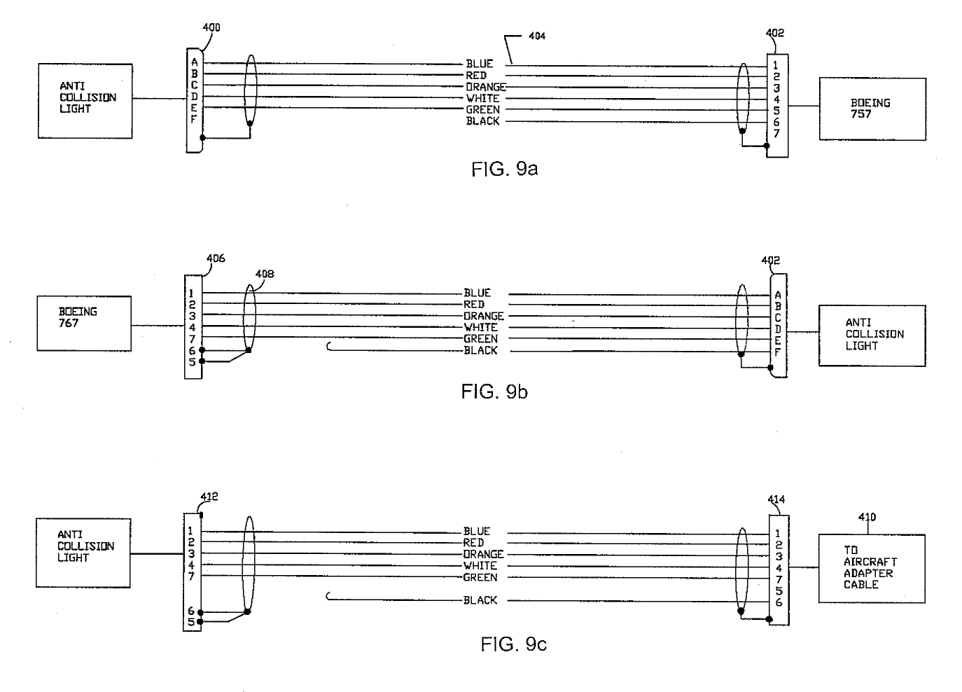

Referring to FIGS. 9a, 9b and 9c, adapter cables are shown for connecting the anti-collision light of the instant invention to different aircraft. These adapter cables are configured so that connectors on the aircraft side fit to corresponding connectors in the aircraft for the replaced anti-collision lights. As should be apparent, conductors between the aircraft connector of the adapter cable and the connector to the anti-collision light may be arranged appropriately so that power, common, chassis ground and a synchronization signal are applied to the same terminals of the anti-collision light no matter what type aircraft the light is mounted in. Here, by way of illustration, FIG. 9a schematically shows an adapter cable for electrically connecting the anti-collision light to a Boeing 757 aircraft, FIG. 9b shows an adapter cable for connecting the anti-collision light to a Boeing 767 aircraft, and FIG. 9c illustrates an extension cable for extending a length of any given cable. With respect to FIG. 9a, a connector 13 (FIG. 1) on the anti-collision light is an aircraft-grade connector, and is provided with six connectors, such as pins, that are engageable with corresponding connectors, such as receptacles, in plug 400. As shown, these plug connectors are labeled A-F. On the Boeing 757 side is a similar connector, with a plug 402 interfacing with the aircraft plug. In this adapter cable 404, conductors connect directly between connectors A-F and 1-6, respectively. Potentials and signals on the aircraft connector 402 are such that pin 1 carries 115 volts AC, 400 cycle power, pin 2 carries aircraft common, pin 3 carries chassis ground, and pin 4 carries a synchronization signal. Pins 5 and 6 are not used. FIG. 9b illustrates another adapter cable for connecting the anti-collision light to a Boeing 767 aircraft. The connector 402 remains the same, while connector 406 to the aircraft is different in that the green conductor is connected to pin 7 instead of 5, and pins 6 and 7 are connected to conductor shield 408.

FIG. 9c illustrates an extension table that extends between an adapter cable 410 and the anti-collision light. Here, conductors 1-4 and 7 are respectively connected between connectors 412 and 414.

Having thus described my invention and the manner of its use, it should be apparent by those skilled in the relevant arts that incidental changes may be made thereto that fairly fall within the scope of the following appended claims, wherein we claim;

1. An anti-collision light for large commercial and passenger-carrying aircraft comprising:
an enclosure containing said anti-collision light, said enclosure further comprising:
a transparent dome on an exterior side of said aircraft,
a housing in an interior side of said aircraft, said housing sealably fitted to said transparent dome,
a plurality of circuit boards, each circuit board of said plurality of circuit boards having a plurality of high intensity LEDs mounted around one side thereof, for directing light away from said circuit board,
a plurality of disks, each disk of said disks having an axis, and each disk of said disks having an edge configured to serve as a reflector that receives light from said LEDs and focuses emitted said light so that said light is focused generally in a plurality of plane regions 360 degrees around said axis of each said disk, each plane region of said plurality of plane regions containing a selected intensity of light,
a power supply for powering said LEDs, said power supply mounted in said enclosure and receiving power from said aircraft so that said anti-collision light is completely self contained and mountable in different types of said aircraft.

2. An anti-collision light as set forth in claim 1 wherein said plurality of disks are each configured with broad, flat opposing sides, and constructed of a heat transfer material, and said plurality of circuit boards and said plurality of disks are connected together in a stack so that each side of each said circuit board is in contact with a broad, flat side of a respective one of said disks so that heat from said plurality of circuit boards is transferred from both sides of each of said plurality of circuit boards and dissipated in said disks.

3. An anti-collision light as set forth in claim 1 wherein said edges of said disks are generally configured as half offset parabolic reflectors for focusing said light into said plurality of plane regions.

4. An anti-collision light as set forth in claim 3 wherein each edge of said plurality of disks is generally defined by:
Ax²+Bxy+Cy²+Dx+Ey+F=0.

5. An anti-collision light as set forth in claim 4 wherein each said edge of each said disk is configured having a plurality of conical facets wherein an angle of each conical facet of said conical facets is selected so that each said conical facet projects light from said LEDs into a discrete plane 360 degrees around each said axis of each said disk.

6. An anti-collision light as set forth in claim 5 wherein angles of said conical facets are selected:
so that light focused in a first plane region of said plurality of plane regions diverging from about 0-5 degrees normal to said axis is of an intensity of at least 400 candela,
so that light focused in a second plane region of said plurality of plane regions diverging from about 5-10 degrees normal to said axis is of an intensity of at least 240 candela,
so that light focused in a third plane region of said plurality of plane regions diverging from about 10-20 degrees normal to said axis is of an intensity of at least 80 candela,
so that light focused in a fourth plane region of said plurality of plane regions diverging from about 20-30 degrees normal to said axis is of an intensity of at least 40 candela, and
so that light focused in a fifth plane region of said plurality of plane regions diverging from about 30-75 degrees normal to said axis is of an intensity of at least 20 candela.

7. An anti-collision light as set forth in claim 1 further comprising a plurality of adapter cables, at least one adapter cable for each particular type of aircraft to which said anti-collision light may be mounted, for electrically connecting said anti-collision light directly to at least power supplied from said particular type of aircraft.

8. An anti-collision light as set forth in claim 2 wherein each said LED has a heat transfer pad, and said circuit board is configured having a layer of thermal transfer material therein, with each said thermal transfer pad of each said LED being in contact with a respective said layer of thermal transfer material, for transferring heat away from said LEDs.

9. An anti-collision light as set forth in claim 1 further comprising a microcontroller mounted in said enclosure, and configured for controlling a flash rate of said LEDs.

10. An anti-collision light as set forth in claim 9 wherein said microcontroller is also configured to detect a synchronization signal, and flash said LEDs responsive to said synchronization signal.

11. An anti-collision light as set forth in claim 9 wherein said microcontroller is configured to first attempt to detect a synchronization signal, and if a synchronization signal is not detected, then said microcontroller flashes said LEDs at predetermined intervals.

12. An anti-collision light as set forth in claim 7 further comprising a plurality of differently configured adapter plates so that said anti-collision light may be fitted to said different types of aircraft by removing an existing anti-collision light and existing power supply and installing said adapter plate to receive said anti-collision light and said adapter cable for coupling at least 115 VAC 400 cycle power from said aircraft to said anti-collision light.

13. An anti-collision light as set forth in claim 4 further comprising:
a first disk supported by said housing, said first disk having a reflective edge at about a 45 degree angle with respect to said axis, and mounted to reflect light away from said aircraft,
a first circuit board in intimate thermal contact on one side thereof with said first disk, with said plurality of LEDs on said first circuit board facing away from said first disk,
a second disk on an opposite side of said first circuit board and in intimate thermal contact therewith so that said plurality of conical facets on said edge of said second disk receives said light from said plurality of LEDs and said first circuit board,
a second circuit board on said second disk, and in intimate thermal contact therewith, said second board oriented so that said plurality of LEDs thereon facing away from said second disk,
a third disk on said second circuit board and in intimate thermal contact therewith so that said plurality of conical facets on said edge of said third disk receives light from said plurality of LEDs on said second circuit board,
a third circuit board on said third disk and in intimate thermal contact therewith, said third circuit board oriented so that said plurality of LEDs thereon facing away from said third disk,
a fourth disk on said third circuit board and in intimate thermal contact therewith so that said plurality of conical facets on said edge of said fourth disk receives light from said plurality of LEDs on said third circuit board,
a fourth circuit board on said fourth disk and in intimate thermal contact therewith, said fourth circuit board oriented so that said plurality of LEDs face away from said fourth disk,
a fifth disk on said fourth circuit board and in intimate thermal contact therewith, with said conical facets on said edge of said fifth disk receiving light from said plurality of LEDs on said fourth circuit board.

14. An anti-collision light comprising:
a housing adapted to be fitted within an anti-collision light opening of said aircraft wherein an existing anti-collision light and power supply therefor have been removed leaving an opening in said aircraft, said housing fitted in said opening using:
an adapter plate configured for being fitted to said aircraft, and having an opening for receiving said housing,
an adapter cable configured to electrically connect said anti-collision light to at least 115 VAC 400 cycles power directly from said aircraft, said adapter plate and said adapter cable specifically configured for that particular aircraft type,
a power supply mounted in said housing for powering said plurality of LEDs, said power supply connected by said adapter cable to said 115 VAC 400 cycle power from said aircraft.
a transparent dome mounted to said housing, said housing and said dome having an axis generally normal to a fuselage of said aircraft,
a plurality of high-intensity LEDs supported in said dome, and oriented to project light generally parallel to said axis,
a reflector for receiving light from each LED of said plurality of LEDs, each said reflector configured having a plurality of conical facets, each conical facet of said conical facets configured to focus light from a respective said LED in a respective discrete plane, and in directions within about 75 degrees with respect to a plane normal to said axis, and wherein light distributed by said conical facets within a plane region of about 5 degrees with respect to said plane normal to said axis is of an intensity of at least 400 candela.

15. An anti-collision light as set forth in claim 16 wherein each said reflector for each said LED is on an edge of a disk configured to focus light from each said LED.

16. An anti-collision light as set forth in claim 15 wherein angles of said conical facets focus light from said plurality of LEDs so that:
light distributed 360 degrees around said axis and 5-10 degrees with respect to said plane normal to said axis is of an intensity of at least 240 candela,
light distributed 360 degrees around said axis and 10-20 degrees with respect to said plane normal to said axis is of an intensity of at least 80 candela,
light distributed 360 degrees around said axis and 20-30 degrees with respect to said plane normal to said axis is of an intensity of at least 40 candela, and
light distributed 360 degrees around said axis and 30-75 degrees with respect to said plane normal to said axis is of an intensity of at least 20 candela.

17. An anti-collision light as set forth in claim 19 further comprising control means mounted in said housing, for controlling a flash rate of said LEDs.

18. An anti-collision light as set forth in claim 17 wherein said control means is configured to first attempt to detect a synchronization pulse, and if said synchronization pulse is not found, then said control means flashes said LEDs at predetermined intervals.

19. An anti-collision light as set forth in claim 14 wherein each said reflector also is as a heat sink to carry heat away from said plurality of LEDs.
